(19) United States
(12) Patent Application Publication
(10) Pub. No.: US 2023/0339770 A1
(43) Pub. Date: Oct. 26, 2023

(54) HIGH PURITY IRON-BEARING MATERIALS AND SYSTEMS AND METHODS OF PRODUCTION THEREOF

(71) Applicant: FORM ENERGY, INC., Somerville, MA (US)

(72) Inventors: William Henry WOODFORD, Somerville, MA (US); Thomas CONRY, San Francisco, CA (US); Alex LUYIMA, Burlington, MA (US)

(21) Appl. No.: 18/306,812

(22) Filed: Apr. 25, 2023

Related U.S. Application Data
(60) Provisional application No. 63/363,556, filed on Apr. 25, 2022.

(51) Int. Cl. C01G 49/02; C21B 13/14

(52) U.S. Cl. CPC C01G 49/02; C21B 13/14; C01P 2006/80

(57) ABSTRACT

The present disclosure is directed to high-purity iron materials and systems and methods of producing such high-purity iron materials based on cost-effective transformation of low-cost iron feedstocks. In general, the methods of production using the systems described herein may include acid leaching low-purity iron ores to create an iron-rich acid solution, which may be purified to remove residual soluble impurities and hydrolyzed to produce high purity iron oxide powder. The high purity iron oxide powder may be reduced to form high purity iron metal suitable for a variety of end-uses, including use in batteries.

### CROSS-REFERENCE TO RELATED APPLICATIONS

This application claims the benefit of priority to U.S. Provisional Patent Application 63/363,556, filed Apr. 25, 2022, the entire contents of which are hereby incorporated herein by reference.

### BACKGROUND

Iron-based batteries, such as iron-air, iron-nickel, and iron-manganese oxide batteries, are promising candidates for long-duration energy storage due to the low cost and high abundance of iron. Generally, the lowest-cost iron materials are those of low purity. This is in tension with the general requirements of batteries, which often require high purity input materials to reduce efficiency losses and degradation caused by impurities (e.g., as a result of catalysis of unwanted side reactions). That is, common impurities in low-cost iron materials such as silica, calcia, magnesia, alumina, manganese oxide, titania, etc. (collectively “gangue”) can cause reduced performance in a battery. Accordingly, there remains a need for low-cost iron materials that are of high purity supporting robust performance of iron-based batteries.

### SUMMARY

The present disclosure is directed to high-purity iron materials and systems and methods of producing such high-purity iron materials based on cost-effective transformation of low-cost iron feedstocks. In general, the methods of production using the systems described herein may include acid leaching low-purity iron ores to create an iron-rich acid solution, which may be purified to remove residual soluble impurities and hydrolyzed to produce high purity iron oxide powder. The high purity iron oxide powder may be reduced to form high purity iron metal suitable for a variety of end-uses, including use in batteries.

According to one aspect, an iron metal may have an apparent density of less than 3 g/cc and silica content less than 0.5 wt %.

According to another aspect, an iron oxide material may have silica content less than 0.5 wt %.

According to yet another aspect, a method of producing iron-containing material may include direct reducing an iron oxide material having silica content less than 0.5 wt % into an iron material having an apparent density of less than 3 g/cc and silica content less than 0.5 wt %. In some implementations, the iron oxide material may be a powder.

In certain implementations, the method may further include hydrolyzing a solution of iron in an acidic lixiviant to form the iron oxide material. Hydrolyzing the solution to form the iron oxide material may include spray roasting the solution to form the iron oxide material. Further or instead, hydrolyzing the solution to form the iron oxide material may include fluidized bed hydrolysis of the solution to form the iron oxide material. In some instances, hydrolyzing the solution may include adding steam. Further or instead, hydrolyzing the solution may include adding water to the solution to maintain a concentration of the iron in the solution below a saturation level of iron in the acidic lixiviant.

In some implementations, the method may further include dissolving an iron-bearing material in the acidic lixiviant to form the solution of iron in the acidic lixiviant. In some instances, dissolving the iron-bearing material in the acidic lixiviant may include recycling the acidic lixiviant separated from the iron in hydrolysis of the solution of iron in the acidic lixiviant. Further, or instead, dissolving the iron-bearing material may include heating the solution to at least 40° C. Additionally, or alternatively, dissolving the iron-bearing material may include directing energy into the solution, wherein the energy is one or more of ultrasonic, mechanical microwave irradiation, or UV light irradiation. In some instances, the iron-bearing material may be a feedstock of particles having an average particle size of 20-500 microns. Further, or instead, the acidic lixiviant may include hydrochloric acid. Additionally, or alternatively, the iron-bearing material may include one or more of iron ore, scrap metal, mining tailings, mineral processing tailings, end-of-life battery electrodes, or end-of-life batteries.

In certain implementations, the method may include removing at least a portion of one or more soluble impurities from the solution of iron in the acidic lixiviant, wherein the solution of iron in the acidic lixiviant is hydrolyzed with the one or more soluble impurities removed from the solution. The soluble impurities may include one or more of silicon, aluminum, calcium, magnesium, chromium, titanium, manganese, vanadium, or copper.

In some implementations, the method may include fabricating a component of a battery, wherein the component includes the iron material.

In certain implementations, the method may include fabricating steel including the iron material.

### DESCRIPTION OF THE DRAWING

FIG. 1 is a block diagram of a system for producing high-purity iron material from iron feedstock, the system including a leaching reactor, a purifier, a spray roaster, and a post-processing station.

### DETAILED DESCRIPTION

Embodiments will be described in detail with reference to the accompanying drawings, in which exemplary embodiments are shown. The foregoing may, however, be embodied in many different forms and should not be construed as limited to the exemplary embodiments set forth herein. All flows of material described herein may flow through conduits (e.g., pipes and/or manifolds) or other forms of material transport, unless otherwise specified or made clear from the context.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the teaching of this disclosure.

As used herein and unless otherwise specified or made clear from the context, the term “apparent density” shall be understood to refer to the mass of a unit volume of powder, usually expressed as grams per cubic centimeter, determined by a specified method such as ASTM B212-17 and/or ASTM B417-13, with the entire contents of each of these testing standards hereby incorporated herein by reference.

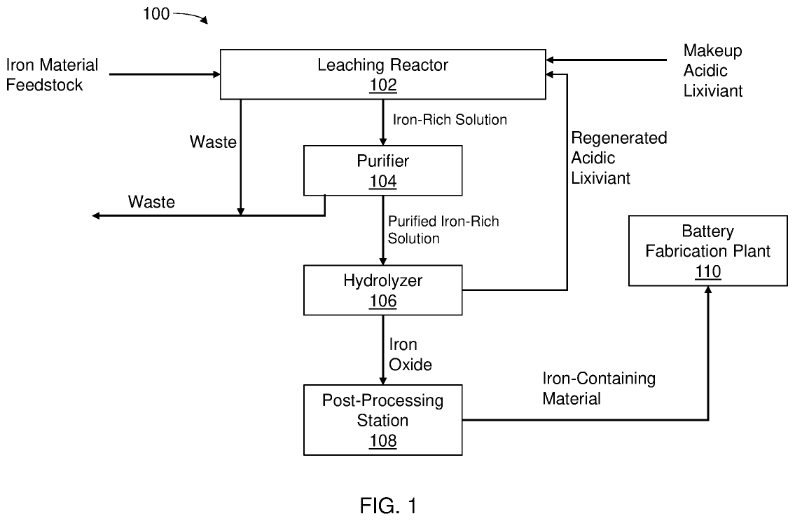

Referring now to FIG. 1, a system 100 may include a leaching reactor 102, a purifier 104, a hydrolyzer 106, and a post-processing station 108. The system 100 may be used for scalable and cost-effective transformation of low-cost iron feedstocks into high-purity iron metal suitable for a variety of end-uses, including for use in batteries. Thus, in certain implementations, the system 100 may additionally, or alternatively, include a battery fabrication plant 110. As described in greater detail below, the system 100 may be used to carry out methods of production including acid leaching low-purity iron ores to create an iron-rich acid solution, which may be purified to remove residual soluble impurities and additionally, or alternatively, may be hydrolyzed to produce high-purity iron oxide powder. The high purity iron oxide powder may be reduced to form high-purity iron metal suitable for a variety of end-uses, such as end-uses in batteries, iron-making, and/or steel-making. As compared to conventional processes for iron metal production using melt processing operations (e.g., in a blast furnace, direct reduction in a shaft furnace combined with electric arc furnace melting, etc.), the system 100 may be used to carry out techniques of iron metal production that facilitate achieving lower-cost in obtaining high-purity iron metal. Stated differently, the presently described techniques facilitate producing higher-purity iron metal at a given cost. For example, the system 100 may be used to upgrade blast furnace iron ore to quality levels exceeding that of direct reduced (DR) grade ore without requiring additional mechanical comminution, magnetic separation, or floatation.

In use, as also described in greater detail below, the system 100 may remove impurities from iron materials to low levels through the use of liquid-phase purifications, which are low-cost and scalable, key requirements for end-uses such as battery fabrication for multi-day energy storage. As an example, the system 100 may carry out the following generalized process steps to produce high-purity iron metal with low apparent density: 1) creating an iron-rich solution; 2) removing soluble impurities; 3) hydrolyzing to produce iron oxide powder; and 4) post-processing and end-use. Each of these steps are described in the following sections.

1. Creating an Iron-Rich Solution

Iron materials (e.g., natural ores and other forms such as oxides, hydroxides, partially metallic, metallic, and/or sulfide) may be beneficiated (sorted) to form an iron material feedstock of a predetermined particle size (for example, average particle size of 20-500 microns).

The iron material feedstock may be introduced into the leaching reactor 102, where the iron material feedstock may be combined with an acidic lixiviant (e.g., a solvent such as hydrochloric acid (HCl)) to prepare a solution rich in iron. Advantageously, as compared to other methods of iron ore purification, many of the impurity phases, such as silica (e.g., SiO2 mainly in the form of quartz, alumino-silicates (kaolin)), are insoluble in acid such that acid dissolution (leaching) carried out in the leaching reactor 102 readily separates iron from impurities. Further, or instead, iron material feedstocks that are relatively impure (e.g., high gangue content) may be efficiently upgraded to a higher purity output from the leaching reactor 102.

The concentration of the acidic lixiviant introduced into the leaching reactor 102 may be between 1-15 mol/L (M) and the iron concentration of the iron-rich solution produced by the leaching reactor 102 may be between 0.01-10 M. Acidic lixiviant regenerated from the hydrolyzer 106 may be introduced back into the leaching reactor 102. Additionally, or alternatively, a supplemental amount of makeup acidic lixiviant (referred to herein as “makeup acidic lixiviant”) to offset material losses in a closed-loop process. In certain implementations, the acidic lixiviant regenerated from the hydrolyzer 106 is not introduced back into the leaching reactor 102 and only fresh acidic lixiviant is supplied is supplied into the leaching reactor 102. Increasing the ionic strength of ions (e.g., chloride ions) in the acidic lixiviant—such as using a combination of acid (e.g., hydrochloric acid) and other lixiviants (e.g., other chloride lixiviants)—may increase the dissolution of the iron material feedstock into the solution rich in iron.

While the iron-rich solution may be formed in the leaching reactor 102, the iron-rich solution may be additionally, or alternatively, supplied directly from another chemical process. For example, byproducts of titanium refining (ilmenite processing), such as iron chloride and/or iron sulfate, may be supplied directly to the purifier 104 and used in the remaining steps of processes carried out by the system 100. More generally, the system 100 may be flexible to use various iron material feedstocks and further, or instead, may include the ability to switch between acid leached iron ore and other iron feedstocks.

In certain implementations, the iron material feedstock introduced into the leaching reactor 102 may additionally, or alternatively, include scrap metal. For example, the iron material feedstock introduced into the leaching reactor 102 may include scrap or end-of-life battery electrodes and/or end-of-life batteries as the iron source. Further, or instead, the iron material feedstock may include end-of-life electronic waste as the iron source. Additionally, or alternatively, the iron material feedstock introduced into the leaching reactor 102 may include mine tailings (such as red mud, pyrite ore from base metals processing, jarosite and goethite residues from zinc extraction processes, etc.) in addition to or instead of iron ore.

In some implementations, acid leaching in the leaching reactor 102 may be accelerated by the addition of energy to the leaching reactor 102. For example, acid leaching in the leaching reactor 102 may be accelerated through the addition of heat (e.g., heating the acid solution to at least 40° C.), pressure (e.g., autoclaving at above one atmosphere), sound (ultrasonication), mechanical agitation (stirring), microwave irradiation, UV light irradiation, or a combination thereof. Additionally, or alternatively, acid leaching in the leaching reactor 102 may be accelerated by the addition of an oxidizing agent such as oxygen (O2), chlorine (Cl2), and/or hydrogen peroxide (H₂O₂). This may be especially useful for acid leaching in instances in which the iron material feedstock includes high levels of sulfur and/or organic matter. In certain instances, the refractory iron ore (e.g., pyrite ore, high sulfide containing ore, high carbonaceous containing iron ore, etc.) that is difficult to dissolve may be further, or instead, subjected to an electrochemical oxidizing process. That is, the refractory iron ore may be coupled to an electrically conductive electrode held at an oxidizing (anodic) potential and a counter electrode may be held at a less oxidizing (more cathodic) potential to accelerate the rate of leaching.

In some instances, multiple acids may be used to enhance the dissolution (leaching) rate of the iron material feedstock in the leaching reactor 102. For example, hydrochloric acid and oxalic acid may be used together to enhance the iron dissolution rate into the iron-rich solution produced by the leaching reactor 102.

2. Removing Soluble Impurities

In the iron-rich solution (also known as a pregnant leach solution (PLS)) produced by the leaching reactor 102, additional soluble impurities (e.g., silicon, aluminum, calcium, magnesium, chromium, titanium, manganese, vanadium, copper, etc.) may be retained in the solution phase. Thus, in some instances, the iron-rich solution from the leaching reactor 102 may be introduced into a purifier 104 to remove soluble impurities in the iron-rich solution to produce a purified iron-rich solution. As used in this context, the purified iron-rich solution exiting the purifier 104 shall be understood to be distinguished from the iron-rich solution introduced into the purifier 104 in that the purified iron-rich solution has a lower volumetric concentration of at least one soluble impurity in the iron-rich solution.

For example, in the purifier 104, the soluble impurities in the iron-rich solution from the leaching reactor 102 may be removed using one or more of: selective adsorption (e.g., ion-exchange and activated carbon adsorption); solvent extraction (e.g., using a solvating extractant, a cation exchanger extractant, a chelating extractant, and/or an anionic exchange extractant); chemical oxidation (e.g., addition of H2O2, O2, and/or Cl2); addition of basic chemicals (e.g., sodium carbonate, sodium hydroxide, and/or a combination of base solutions) to increase pH and selectively precipitate out impurities; addition of a sulfide source to precipitate out impurities; electrochemical oxidation; or heating and/or cooling to effect a precipitation (crystallization) reaction. Further, or instead, sulfide ions (e.g., sodium sulfide and/or hydrogen sulfide gas) may be added to selectively precipitate out impurities as metal sulfides. In some implementations, removing soluble impurities from the iron-rich solution in the purifier 104 may include cementation in which metallic iron, iron scrap, and/or steel scrap is added to the iron-rich solution to reduce iron III chloride to iron II chloride and to precipitate elements more noble than iron (e.g., elements such as copper and nickel). Further, or instead, in the purifier 104, the addition of metallic scrap to the iron-rich solution may facilitate increasing the pH of the iron-rich solution and, when combined with pH adjustment, may facilitate precipitating and removing dissolved silica, titanium, aluminum, chromium, and/or copper impurities from the iron-rich solution when the pH of the iron-rich solution is between about 4-6.5. In instances in which removal of dissolved impurities from the iron-rich solution in the purifier 104 includes cooling and/or heating (crystallization), the iron-rich solution may be heated to evaporate excess moisture and the resulting iron chloride-saturated solution may be fed into a crystallizer in which iron II chloride crystals may form.

In some implementations, the purification process carried out in the purifier 104 may be a single unit operation while, in other implementations, the purification process carried out in the purifier 104 may include multiple unit operations. Aspects of the purification process(es) carried out in the purifier 104 may be largely impacted by the composition and mineralogy of the iron material feedstock and further, or instead, may be tuned to adjust the quality of the output of high purity iron oxide materials. Additionally, or alternatively, the purification process(es) carried out in the purifier 104 may be tuned to facilitate stable production of output high purity iron oxide materials as the composition of the iron material feedstock varies over time.

3. Hydrolyzing to Produce Iron Oxide Powder

In general, iron chloride decomposition and acid regeneration may be effected on the purified iron-rich solution from the purifier 104. For example, by a spray-roasting process may be carried out on the purified iron-rich solution in the spray roaster 106. Additionally, or alternatively, the iron chloride decomposition and acid regeneration may be carried out in a fluidized bed reactor.

In some implementations, a hydrolysis reaction in the hydrolyzer 106 may include mixing the purified iron-rich solution with air (e.g., at elevated temperature above 150° C. such as greater than about 500° C. and less than about 800° C.). In some instances, additional water (steam) may be added to promote rapid hydrolysis. For example, water may be added to the purified iron-rich solution to maintain the concentration of iron in the solution below the saturation level. Further, or instead, additional oxygen (O2) may added to the purified iron-rich solution in the hydrolyzer 106. Further, or instead, in instances in which pyro hydrolysis such as spray roasting is used to hydrolyze the purified iron-rich solution in the hydrolyzer 106, the off-gas may be rich in HCl-water vapor mixture and, for example, this HCl-water vapor mixture may be absorbed into a packed bed absorber, where water may be used to strip (wash out) absorbed HCl to produce regenerated hydrochloric acid that may be returned to the leaching reactor 102. In instances in which hydrolysis in the hydrolyzer 106 includes spray roasting, the iron oxide produced from the spray roasting may be rinsed or washed, as may be useful for adjusting chemical properties of the iron oxide.

4. Post-Processing and End-Use

While the iron oxide produced by the hydrolyzer 106 may be directly used in an end-use application in some instances (such as being used directly in the battery fabrication plant 110—skipping the post-processing station 108—for fabrication of a battery in which the negative electrode is formed in a discharged state), the iron oxide may undergo one or more post-processing steps in a post-processing station 108 to make the iron oxide into an iron-containing material suitable—or in, some cases, more suitable—for a particular end-use. As used in this context, the iron-containing material formed by one or more post-processing operations carried out in the post-processing station 108 may include changes to one or more chemical and/or physical properties of the iron oxide introduced into the post-processing station 108 from the hydrolyzer 106. For example, in the post-processing station 108, the iron oxide from the hydrolyzer 106 may be blended with other iron-bearing materials before being incorporated into a battery in the battery fabrication plant 110. Further, or instead, in the post-processing station 108, the iron oxide from the hydrolyzer 106 may be reduced to iron metal before being used in a battery in the battery fabrication plant 110. Additionally, or alternatively, the iron oxide from the hydrolyzer 106 may be partially reduced to an intermediate oxidation state between iron oxide and iron metal before being used in a battery in which the negative electrode is formed at an intermediate state of charge in the battery fabrication plant 110. In some instances, the partially reduced material produced from the iron oxide may be blended with other iron-bearing materials such that the combination of the iron oxide and the other iron-bearing materials is incorporated into a battery in the battery fabrication plant 110.

In certain implementations, the iron oxide from the hydrolyzer 106 may be used directly a feedstock into a “fines-based” direct reduction process carried out in the post-processing station 108.

In some instances, in the post-processing station 108, the iron oxide from the hydrolyzer 106 may be agglomerated into iron oxide pellets by addition of a binder such as bentonite or sodium alginate or other organic binders such as carboxymethyl cellulose followed by pelletization or granulation according to methods known in the art, such as disc or drum pelletization. In some cases, the resulting pellets may be used as an input to a direct reduction process such as a shaft furnace process or a fluidized bed process carried out in the post-processing station 108. Further, or instead, the reducing gas for a direct reduction process carried out in the post-processing station 108 may include natural gas (methane), reformed natural gas, hydrogen (including but not limited to hydrogen derived from methane steam reforming, in-situ reforming, methane pyrolysis, water electrolysis, and/or other methods).

In certain implementations, the iron oxide from the hydrolyzer 106 may be direct reduced via a coal or coke-based process carried out in the post-processing station 108. In some implementations, the iron oxide from the hydrolyzer 106 may be direct reduced in a rotary or tunnel kiln in the post-processing station 108. Further, or instead, high-purity iron that is direct reduced from the iron oxide in the post-processing station 108 may be advantageously used in steelmaking. That is, a high-purity iron that is direct reduced from the iron oxide in the post-processing station 108 may contain low amounts of SiO2, CaO, MgO, MnO, Al₂O₃—, etc. and, thus, may facilitate producing less slag in the steelmaking process. In some instances, the high-purity iron that is direct reduced from the iron-oxide in the post-processing station 108 may be used in a blast furnace, electric arc furnace, or other steelmaking operation.

In some instances, the high-purity iron that is direct reduced from the iron oxide in the post-processing station 108 may be used in a battery such as an iron-air, iron-nickel, or iron-manganese oxide battery. For example, the high-purity iron that is direct reduced in the post-processing station 108 may be prepared into a battery electrode by various methods known in the art such as sintering, coating, and drying, or by incorporation into a pocket plate electrode. Additionally, or alternatively, the high-purity iron that is direct reduced from the iron oxide in the post-processing station 108 may be formed into a battery electrode through a hot compaction process, such as the hot compaction process described in U.S. Pat. App. Pub. 2022/0149359 A1, entitled “METHOD OF IRON ELECTRODE MANUFACTURE AND ARTICLES AND SYSTEMS THEREFROM,” published May 12, 2022, the entire contents of which are hereby incorporated herein by reference. U.S. Pat. App. Pub. 2022/0149359 A1 also describes various embodiments and provides specific examples of aspects of electrochemical cells, such as rechargeable batteries using iron electrodes (e.g., iron negative electrodes), and design, manufacture, and processing features of electrochemical cells, such as iron electrode manufacturing methods which may be made at least in part using high-purity iron that is direct reduced from the iron oxide in the post-processing station 108.

While the preceding description has focused on hydrochloric acid, it shall be appreciated that this is for the sake of clear and efficient description. Unless otherwise specified or made clear from the context, the acidic lixiviant may include any one or more of various acids and combinations thereof, including hydrochloric acid (HCl), sulfuric acid (H2SO4), nitric acid (HNO3), hydrofluoric acid (HF), oxalic acid (C2H2O4) and combinations and permutations thereof.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. An iron metal having an apparent density of less than 3 g/cc and silica content less than 0.5 wt %.

2. An iron oxide material having silica content less than 0.5 wt %.

3. A method of producing iron-containing material, the method comprising:
direct reducing an iron oxide material having silica content less than 0.5 wt % into an iron material having an apparent density of less than 3 g/cc and silica content less than 0.5 wt %.

4. The method of claim 3, wherein the iron oxide material is a powder.

5. The method of claim 3, further comprising hydrolyzing a solution of iron in an acidic lixiviant to form the iron oxide material.

6. The method of claim 5, wherein hydrolyzing the solution to form the iron oxide material includes spray roasting the solution to form the iron oxide material.

7. The method of claim 5, wherein hydrolyzing the solution to form the iron oxide material includes fluidized bed hydrolysis of the solution to form the iron oxide material.

8. The method of claim 5, wherein hydrolyzing the solution includes adding steam.

9. The method of claim 5, wherein hydrolyzing the solution includes adding water to the solution to maintain a concentration of the iron in the solution below a saturation level of iron in the acidic lixiviant.

10. The method of claim 5, further comprising dissolving an iron-bearing material in the acidic lixiviant to form the solution of iron in the acidic lixiviant.

11. The method of claim 10, wherein dissolving the iron-bearing material in the acidic lixiviant includes recycling the acidic lixiviant separated from the iron in hydrolysis of the solution of iron in the acidic lixiviant.

12. The method of claim 10, wherein dissolving the iron-bearing material includes heating the solution to at least 40° C.

13. The method of claim 10, wherein dissolving the iron-bearing material includes directing energy into the solution, wherein the energy is one or more of ultrasonic, mechanical microwave irradiation, or UV light irradiation.

14. The method of claim 10, wherein the iron-bearing material is a feedstock of particles having an average particle size of 20-500 microns.

15. The method of claim 10, wherein the acidic lixiviant includes hydrochloric acid.

16. The method of claim 10, wherein the iron-bearing material includes one or more of iron ore, scrap metal, mining tailings, mineral processing tailings, end-of-life battery electrodes, or end-of-life batteries.

17. The method of claim 10, further comprising removing at least a portion of one or more soluble impurities from the solution of iron in the acidic lixiviant, wherein the solution of iron in the acidic lixiviant is hydrolyzed with the one or more soluble impurities removed from the solution.

18. The method of claim 17, wherein the soluble impurities include one or more of silicon, aluminum, calcium, magnesium, chromium, titanium, manganese, vanadium, or copper.

19. The method of claim 5, further comprising fabricating a component of a battery, wherein the component includes the iron material.

20. The method of claim 5, further comprising fabricating steel including the iron material.
